(19) United States
(12) Patent Application Publication
(10) Pub. No.: US 2025/0043881 A1
(43) Pub. Date: Feb. 6, 2025

(54) MICRO-GENERATION SELF-ENERGIZED WATER TRANSPORTATION PIPE ADJUSTMENT VALVE DEVICE

(71) Applicant: Ningbo University, Ningbo (CN)

(72) Inventors: Rongyue Zheng, Ningbo (CN); Zesong Yang, Ningbo (CN); DAVID ZHIWEI ZHU, Ningbo (CN)

(21) Appl. No.: 18/419,612

(22) Filed: Jan. 23, 2024

(30) Foreign Application Priority Data
Jul. 31, 2023 (CN) 202310948731.8

(51) Int. Cl. F16K 31/04; F16K 5/06; H02K 11/21; H02K 26/00

(52) U.S. Cl. CPC F16K 31/041; F16K 5/0647; H02K 11/21; H02K 26/00

(57) ABSTRACT

A micro-generation self-energized water transportation pipe adjustment valve device is provided comprising a tubular valve outer housing, a valve component fixedly mounted at one end and a rotor component at the other end inside the valve outer housing. A coil winding is disposed on an inner side surface of an end of the valve outer housing. The rotor component comprises a rotor housing, permanent magnet groups and rotor blades spirally distributed on an inner sidewall of the rotor housing. The rotor housing is coaxially and rotatably nested into the valve outer housing. The valve component comprises a switching actuator and an electrically-controlled switching mechanism. A wire connection end of the coil winding is connected with a power transformation and storage module configured to store, in a transformation way, relative rotational induction generation between the rotor component and the coil winding under the drive of water flow.

This application is based upon and claims priority to Chinese Patent Application No. 202310948731.8, filed on Jul. 31, 2023, the entire contents of which are incorporated herein by reference.

### TECHNICAL FIELD

The present disclosure technical field of water conservation and hydraulic power and in particular to a micro-generation self-energized water transportation pipe adjustment valve device.

### BACKGROUND

In the current water channeling and use facilities and its pipe devices, pipe networks are extensively and densely distributed between upper and lower units of water administrations. Various pipes of various diameters are spread to each corner of the cities and surrounding towns. Only when a water pressure is exactly within a given range, namely, cannot be excessively small or large, can the entire pipe network supply water. Excessively small water pressure will lead to unsmooth water supply and excessively large water pressure will cause the pipe burst, pressure waste and water resource waste.

It is a common long-distance water transportation solution to use a booster pump device or create a potential energy by using a height difference of upstream and downstream. Therefore, a large number of flow-regulating and pressure-regulating valve devices are required to slow down and depressurize the upstream water, which not only ensures pressure safety of the water transportation pipes but also helps downstream facilities to directly use the supplied water.

In the present days, the water flow and pressure regulating valves in the water transportation pipes are either monitored and operated by hand or automatically controlled by an externally-connected power source. But, the above two common valve control methods have their respective defects. The valve operation under human control is troublesome and labor-consuming whereas the valve operation under automatic control needs external power source, which can not only bring large consumption due to long-distance power transportation but also increase the device costs. For example, use of an accumulator as energy source may lead to charge and replacement problems arising over time. Furthermore, if the control valves in the pipes are located in special terrains or remote areas, their operations will be extremely difficult, significantly increasing labor costs, time costs and economic costs.

In conclusion, the flow and pressure regulation facilities in the existing water transportation pipes have the technical problems of high labor consumption and high execution costs.

### SUMMARY

The technical problem to be solved in the present disclosure is that the flow and pressure regulation facility in the existing water transportation pipes have the technical problems of high labor consumption and high execution costs.

In order to address the above problems, the present disclosure provides a micro-generation self-energized water transportation pipe adjustment valve device. The device comprises a tubular valve outer housing with both ends connected to a pipe, a valve component fixedly mounted at one end inside the valve outer housing, and a rotor component located at the other end inside the valve outer housing. A coil winding is disposed on an inner side surface of an end of the valve outer housing cooperating with the rotor component. The rotor component comprises a rotor housing, permanent magnet groups uniformly distributed outside the rotor housing and rotor blades spirally distributed on an inner sidewall of the rotor housing. The rotor housing is coaxially and rotatably nested into the valve outer housing. The valve component comprises a switching actuator and an electrically-controlled switching mechanism. A wire connection end of the coil winding is connected with a power transformation and storage module configured to store, in a transformation way, relative rotational induction generation between the rotor component and the coil winding under the drive of water flow. The electrically-controlled switching mechanism is also connected with the power transformation and storage module such that the electrically-controlled switching mechanism is powered by the power transformation and storage module to control a closing or opening degree of the switching actuator.

In the present disclosure, the adjusting valve device has the characteristics of self-adjustment. The coil winding and the permanent magnet group are disposed respectively on the valve outer housing and the rotor housing mutually nested. Under the drive of the water flow toward the rotor blades in the rotor housing, the rotor housing coaxially rotates relative to the valve outer housing to generate power through electromagnetic induction, and the power energy generated by the simple power generator structure is converted and stored by using the power transformation and storage module connected with the coil winding. The electrically-controlled switching mechanism is disposed inside the valve component and connected with the power transformation and storage module and thus the power energy generated by the valve itself is directly used to power the opening or closing movement of the switching actuator.

In this design, the hydraulic potential energy wasted by the position of the flow-regulating and pressure-regulating valve in the conventional pipes is directly converted into electric energy as drive energy for automatic control of the valve, greatly promoting automatic adjustment of water transportation between upstream and downstream of the water pipes. The adjustment power of the valve is generated by the valve itself and not provided by human, which avoids the cases of high wiring costs and difficult construction work occurring in the solutions in which external power source is connected. Furthermore, it is easy to perform further optimization of the automatic control with the design as structure basis. In this way, the technical problems of high labor consumption and high execution costs of the flow-regulating and pressure-regulating facility in the existing water transportation pipes can be solved.

As a preferred solution, the self-adjusting valve device further comprises a feedback adjustment component which comprises a hydraulic pressure sensor disposed at a position in contact with the water flow inside the valve outer housing and a primary control module connected with the hydraulic pressure sensor. The primary control module is connected with the power transformation and storage module and the electrically-controlled switching mechanism in a controlled manner to adaptively adjust a movement output by the electrically-controlled switching mechanism based on collected hydraulic pressure information so as to change the opening or closing action of the switching actuator.

As a preferred solution, the feedback component further comprises a rotation speed measurer connected to the rotor housing in an induction manner to measure a rotation speed of the rotor housing and also connected to the primary control module to output rotation information to a rotation speed module.

As a preferred solution, the valve component further comprises a valve inner chamber disposed inside the valve outer housing. The valve inner chamber has a sphere-like chamber structure. The switching actuator is a valve ball which matches the shape of the valve inner chamber and is capable of adjusting the openness of the valve inner chamber by axial feed. In this way, the specific structure design of the valve component is optimized and better opening/closing and openness adjustment effect can be achieved.

As a preferred solution, the electrically-controlled switching mechanism comprises a valve inner bracket for supporting and connecting the valve ball and a valve drive motor for driving the valve ball to perform axial feed movement. This specific structure design of the electrically-controlled switching component is optimized. By the valve drive motor, the operation of the valve can be performed.

As a preferred solution, a screw rod is coaxially fixed at a base of the valve ball. The valve inner bracket comprises an outer gear nut in thread cooperation with the screw rod. An output shaft of the valve drive motor is engaged with an outer edge of the outer gear nut through a connection gear to output rotation and hence drive the rotation of the outer gear nut so as to drive the screw rod to perform axial feed movement. The specific structure design of the electrically-controlled switching mechanism is optimized. Based on the principle of the nut-screw operation, in combination with the gear transmission, the axial feed movement of the valve ball can be achieved.

As a preferred solution, the valve inner bracket further comprises a bracket housing in which the outer gear nut and the valve drive motor both are received. An end of the bracket housing at the screw rod is further provided with a screw rod sleeve for supporting the screw rod. The bracket housing and the valve inner chamber are fixedly connected via spoke structures. The structural design of the valve inner bracket is optimized to enable the mechanical structure to be more reasonable in layout and stronger in automatic operability.

As a preferred solution, an end of the bracket housing facing toward the rotor component is provided with a convex cone-shaped chamber structure for providing a feed allowance for the screw rod and directing the water flow to have less impact on the bracket housing. The structural design of the above bracket housing is optimized to enable it to more adapt to the water flow circumstances and the working conditions of the screw rod movement.

As a preferred solution, an extension structure extending to the valve outer housing is disposed on an outer end of the valve inner chamber, and turned out at an opening position of the valve outer housing to form a pipe mouth docking structure. An end of the valve outer housing at the rotor component is also provided with a pipe mouth docking structure. Both of the pipe mouth docking structures are used to fixedly dock with upstream and downstream pipes. The pipe mouth docking structure design of the valve structure is optimized to facilitate docking and use of the device.

As a preferred solution, an inlet end of the rotor housing is provided with a flow guide disk structure for uniformly directing the water flow to the position of the rotor blades on the inner sidewall of the rotor housing. The flow guide disk structure comprises a conical flow guide head and water split blades uniformly distributed on an outer edge of the flow guide head. A pointed end of the flow guide head faces toward the incoming water. The tubular structure of the valve generation structure is optimized, ensuring the rotational push of the water flow to the rotor component.

As a preferred solution, an electric control box is disposed at an outer side surface of the valve outer housing, and the power transformation and storage module and the primary control module are both integrated into the electric control box. Furthermore, the primary control module is further connected with a remote communication module. The circuit control structure design of the power generator is optimized.

### BRIEF DESCRIPTION OF THE DRAWINGS

FIG. 1 is a structural schematic diagram illustrating a micro-generation self-energized water transportation pipe adjustment valve device according to the present disclosure.

FIG. 2 is a schematic diagram of a sectional structure of the micro-generation self-energized water transportation pipe adjustment valve device in FIG. 1.

FIG. 3 is a schematic diagram of a partial enlarged structure of the section of the micro-generation self-energized water transportation pipe adjustment valve device in FIG. 2.

FIG. 4 is a structural schematic diagram of the micro-generation self-energized water transportation pipe adjustment valve device in FIG. 1 within a valve outer housing.

Numerals of the drawings 1 to 4 are described below:
1. valve outer housing, 1-1. electric control box, 1-2. pipe mouth docking structure, 1-3. flow guide disk structure, 1-4. flow guide head, 1-5. water split blade, 2. rotor component, 2-1. rotor housing, 2-2. permanent magnet group, 2-3. rotor blade, 3. valve component, 3-1. valve drive motor, 3-2. valve inner chamber, 3-3. cone-shaped chamber structure, 3-4. outer gear nut, 3-5. screw rod sleeve, 3-6. screw rod, 3-7. valve ball, 3-8. bracket housing, and 3-9. spoke structure.

### DETAILED DESCRIPTIONS OF EMBODIMENTS

The technical solutions of the present disclosure will be fully and clearly described below. Apparently, the embodiments described herein are merely some embodiments rather than all embodiments. All other embodiments obtained by those skilled in the arts based on these embodiments in the present disclosure without making creative work shall fall within the scope of protection of the present disclosure.

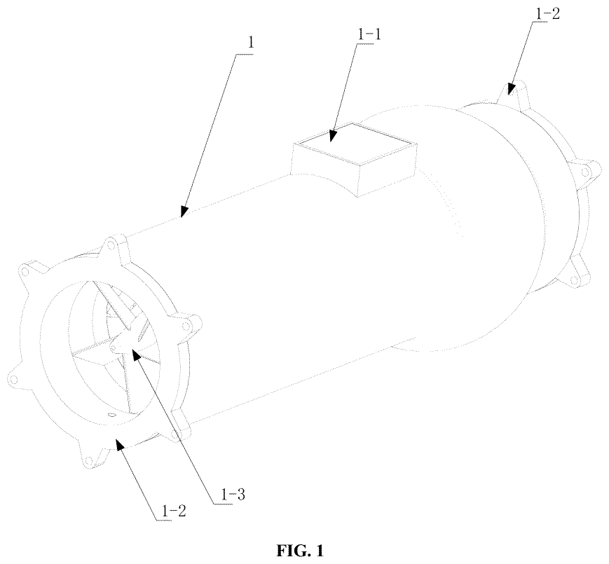

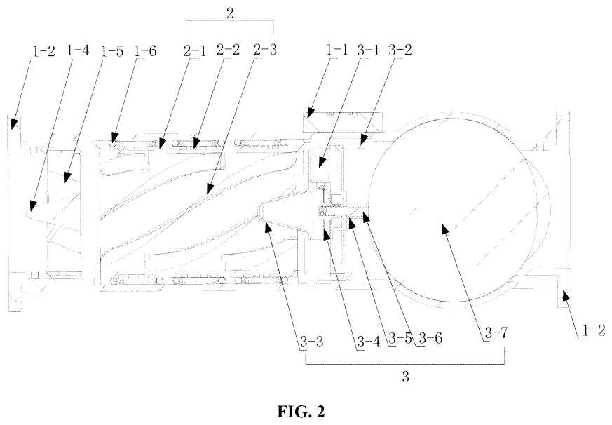

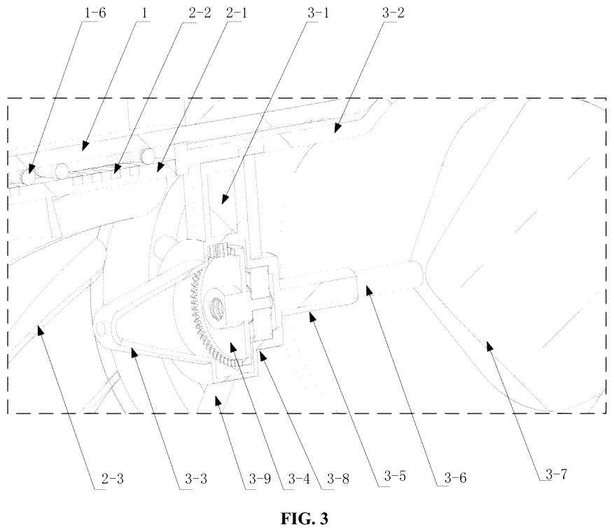

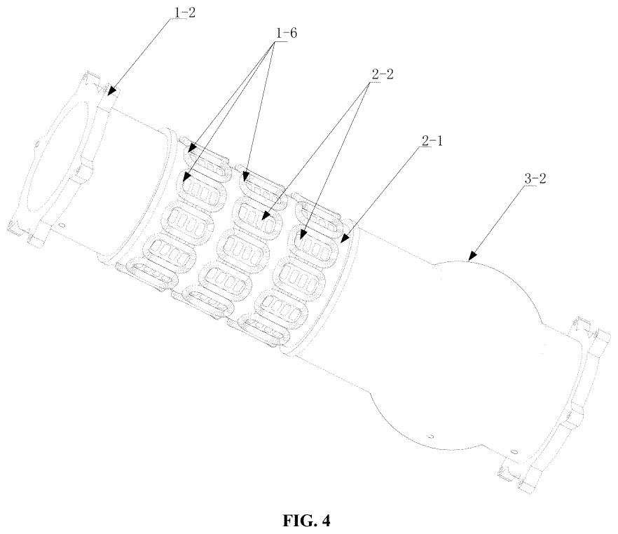

FIG. 1 is a structural schematic diagram illustrating a micro-generation self-energized water transportation pipe adjustment valve device according to the present disclosure; FIG. 2 is a schematic diagram of a sectional structure of the micro-generation self-energized water transportation pipe adjustment valve device in FIG. 1. FIG. 3 is a schematic diagram of a partial enlarged structure of the section of the micro-generation self-energized water transportation pipe adjustment valve device in FIG. 2; and FIG. 4 is a structural schematic diagram of the micro-generation self-energized water transportation pipe adjustment valve device in FIG. 1 within a valve outer housing.

The micro-generation self-energized water transportation pipe adjustment valve device provided by the embodiments of the present disclosure comprises a tubular valve outer housing 1 with both ends connected to a pipe, a valve component 3 fixedly mounted at one end inside the valve outer housing 1, and a rotor component 2 located at the other end inside the valve outer housing 1. A coil winding is disposed on an inner side surface of an end of the valve outer housing 1 cooperating with the rotor component 2. The rotor component 2 comprises a rotor housing 2-1, permanent magnet groups 2-2 uniformly distributed outside the rotor housing 2-1 and rotor blades 2-3 spirally distributed on an inner sidewall of the rotor housing 2-1. The rotor housing 2-1 is coaxially and rotatably nested into the valve outer housing 1. The valve component 3 comprises a switching actuator and an electrically-controlled switching mechanism. A wire connection end of the coil winding is connected with a power transformation and storage module configured to store, in a transformation way, relative rotational induction generation between the rotor component 2 and the coil winding under the drive of water flow. The switching control mechanism is also connected with the power transformation and storage module such that the electrically-controlled switching mechanism is powered by the power transformation and storage module to control a closing or opening degree of the switching actuator.

In the present disclosure, the adjusting valve device has the characteristics of self adjustment. The coil winding and the permanent magnet group are disposed respectively on the valve outer housing and the rotor housing mutually nested. Under the drive of the water flow toward the rotor blades in the rotor housing, the rotor housing coaxially rotates relative to the valve outer housing to generate power through electromagnetic induction, and the power energy generated by the simple power generator structure is converted and stored by using the power transformation and storage module connected with the coil winding. The electrically-controlled switching mechanism is disposed inside the valve component and connected with the power transformation and storage module and thus the power energy generated by the valve itself is directly used to power the opening or closing movement of the switching actuator.

In this design, the hydraulic potential energy wasted by the position of the flow-regulating and pressure-regulating valve in the conventional pipes is directly converted into electric energy as drive energy for automatic control of the valve, greatly promoting automatic adjustment of water transportation between upstream and downstream of the water pipes. The adjustment power of the valve is generated by the valve itself and not provided by human, which avoids the cases of high wiring costs and difficult construction work occurring in the solutions in which external power source is connected. Furthermore, it is easy to perform further optimization of the automatic control with the design as structure basis. In this way, the technical problems of high labor consumption and high execution costs of the flow-regulating and pressure-regulating facility in the existing water transportation pipes can be solved.

Furthermore, when the adjustment valve device is used at a pipe position with large water flow, the power energy generated by water flow impact far exceeds the power energy required for controlling the valve. In this case, the remaining power energy may be transmitted toward outside by the power transformation and storage module. The power generations of multiple self-adjusting valves in a same area can be combined to obtain an effect of a power generation set.

In the technical solution provided by this embodiment, the self-adjusting valve device further comprises a feedback adjustment component which comprises a hydraulic pressure sensor disposed at a position in contact with the water flow inside the valve outer housing and a primary control module connected with the hydraulic pressure sensor. The primary control module is connected with the power transformation and storage module and the electrically-controlled switching mechanism in a controlled manner to adaptively adjust a movement output by the electrically-controlled switching mechanism based on collected hydraulic pressure information so as to change the opening or closing action of the switching actuator. Furthermore, the feedback component further comprises a rotation speed measurer connected to the rotor housing 2-1 in an induction manner to measure a rotation speed of the rotor housing 2-1 and also connected to the primary control module to output rotation information to a rotation speed module.

The design provides further automation optimization design on the basis of self generation and self use: The feedback adjustment structure disposed in the device mainly comprises a sensor at the position in direct contact with the water low inside the valve, and preferably, a surface mount pressure sensor is directly attached to an inner sidewall of the pipe and connected with the primary control module in a controlled manner. The primary control module may adopt a processor device such as an embedded chip device and the like. The primary control module can, based on the hydraulic pressure signal obtained by the pressure sensor, adaptively control the power supply of the power transformation and storage module for the electrically-controlled switching mechanism, so as to control the water flow and water pressure passing through the valve, realizing flow regulation and pressure regulation of the valve and ensuring the safety of the pressure and flow rate in the water pipe. The effect of full automatic control after mounting can be achieved, without any human work, further improving the automatic degree of the valve control.

By obtaining the rotation speed and hydraulic pressure information inside the valve device, the primary control module may directly obtain a real-time flow rate in the pipe through calculation based on preset parameters such as valve pipe diameter (obtained by a real-time openness of the valve in combination with the pipe diameter in a standard opening state), a rotation resistance of the rotor and an intra-pipe standard pressure and flow rate and the like. Therefore, a flow meter generally arranged in the prior water pipes can be directly replaced and more accurate control on the water flow rate of the valve can be achieve more easily, or real-time flow rate information can be fed back to a master control of higher level in a remote communication manner mentioned later.

By disposing the automatic valve with automatic information collection function in the above embodiments in the water pipes, the pressure balance problem of the entire pipe network can be solved, which ensures the pressure value of the entire pipe network is between 1.5 KG and 6 KG and water can be supplied normally and also avoids pipe burst due to excessively large pipe pressure.

The automatic scheduling of water can be achieved. The pressure in a region with excessively large pressure is automatically transitioned to another region with an excessively small pressure to maintain an automatic balance of the pressure within an interval, providing data reference for water network construction and pipe network optimization. In this way, energy consumption can be reduced. While the pressure of the entire water network is maintained in a water supply interval, the number of the working booster bumps at the water supply end can be reduced properly. During the water use peaks and troughs, the device will be automatically shut down to prevent water leakage. By big data analysis of pressure and flow rate, the water leakage can be detected and alerted.

The technical solution of this embodiment is further optimized. The valve component 3 further comprises a valve inner chamber 3-2 disposed inside the valve outer housing 1. The valve inner chamber 3-2 has a sphere-like chamber structure. The switching actuator is a valve ball 3-7 which matches the shape of the valve inner chamber 3-2 and is capable of adjusting the openness of the valve inner chamber 3-2 by axial feed.

This design optimizes the specific structure design of the valve component and better opening/closing and the openness adjustment effect can be achieved. The structure of the valve inner chamber is separated from the valve outer housing to facilitate assembling, repair and replacement of the valve component. The sphere-like chamber structure is preferably a rotatably symmetrical structure which has a central axis cooperating with the valve ball. The feed direction of the valve ball is a central axis direction of the sphere-like chamber. By using the structure, uniform flow limitation of all directions can be achieved with uniform force reception. In this case, the switching structure of the valve is durable and stable.

In the technical solution provided by this embodiment, the electrically-controlled switching mechanism comprises a valve inner bracket for supporting and connecting the valve ball 3-7 and a valve drive motor 3-1 for driving the valve ball 3-7 to perform axial feed movement.

This design optimizes the specific structure design of the electrically-controlled switching component. By the valve drive motor, the operation of the valve can be performed. The feed of the valve ball is powered by the motor. It has the advantages of simple structure and case of control implementation and thus helps accurate control of the feed amount. By using the valve inner bracket, the valve ball is stably limited on the central axis of the sphere-like valve inner chamber, ensuring the directional stability and positional stability of the feed of the valve ball and achieving effective valve effect.

In the technical solution provided by this embodiment, a screw rod 3-6 is coaxially fixed at a base of the valve ball 3-7. The valve inner bracket comprises an outer gear nut 3-4 in thread cooperation with the screw rod 3-6. An output shaft of the valve drive motor 3-1 is engaged with an outer edge of the outer gear nut 3-4 through a connection gear to output rotation and hence drive the rotation of the outer gear nut 3-4 so as to drive the screw rod 3-6 to perform axial feed movement.

This design optimizes the specific structure design of the electrically-controlled switching mechanism. Based on the principle of the nut-screw operation, in combination with the gear transmission, the axial feed movement of the valve ball can be achieved. In the region of the valve inner bracket located at the central axis of the valve inner chamber is provided the outer gear nut and at the central axis of the valve ball in cooperation with it is fixedly connected the screw rod. Both of them cooperate with each other by thread. At a side edge of the outer gear nut is provided a tooth structure which is cooperatively connected with an output shaft gear of the valve drive motor to convey rotational action to drive the outer gear nut to rotate around an axial direction and thus drive the screw rod to perform axial telescoping feed. This transmission structure is simple and effective and can be fitted into the valve inner chamber and the inner structure of the valve ball.

In the technical solution provided by this embodiment, the valve inner bracket further comprises a bracket housing 3-8 in which the outer gear nut 3-4 and the valve drive motor 3-1 both are received. An end of the bracket housing 3-8 at the screw rod 3-6 is further provided with a screw rod sleeve 3-5 for supporting the screw rod 3-6. The bracket housing 3-8 and the valve inner chamber 3-2 are fixedly connected via spoke structures 3-9.

For the mechanical structure design of the electrically-controlled switching mechanism in the above embodiment, further cooperation structure is further optimized to enable the mechanical structure to be more reasonable in layout and stronger in automatic operability. Specifically, the bracket housing structure can house the screw rod, the outer gear nut and the drive motor to achieve waterproof protection for the mechanical transmission structure, ensuring the durability of the valve movement mechanism. An end of the bracket housing from which the screw rod extends is provided with a screw rod sleeve for accommodating and supporting the screw rod to ensure the stability of the feed direction of the valve ball and prevent it from deviating from the central line of the chamber under the action of the water flow.

In the technical solution provided by this embodiment, an end of the bracket housing 3-8 facing toward the rotor component 2 is provided with a convex cone-shaped chamber structure 3-3 for providing a feed allowance for the screw rod 3-6 and directing the water flow to have less impact on the bracket housing 3-8.

The design is further optimized on the basis of the above bracket housing structure to enable the structure to more adapt to the water flow circumstances and the working conditions of the screw rod movement. By splitting the water using the cone-shaped shell protruding toward the incoming water, the impact of the water flow on the valve bracket can be reduced and the durability of the device is improved. Further, by using the convex chamber structure, an accommodation space allowance for the feed of the screw rod is provided, making the mechanical structure layout more reasonable.

In the technical solution provided by this embodiment, an extension structure extending to the valve outer housing 1 is disposed on an outer end of the valve inner chamber 3-2, and turned out at an opening position of the valve outer housing 1 to form a pipe mouth docking structure 1-2. An end of the valve outer housing 1 at the rotor component 2 is also provided with a pipe mouth docking structure 1-2. Both of the pipe mouth docking structures 1-2 are used to fixedly dock with upstream and downstream pipes.

For the application environments of the valve device, its structure is optimized. The pipe mouth docking structure is disposed at both sides of the valve outer housing respectively such that it can be directly mounted to the water pipe or one segment of water pipe can be replaced. This design has general applicability to the water pipes, which ensures easy and quick mounting. Furthermore, by using the pipe mouth docking structure, the valve device is enable to have inner and outer layers, that is, the water connection structure is isolated from the outer non-water-connection structure, facilitating the layout of the electric structure and helping repair and replacement.

In the technical solution provided by this embodiment, an inlet end of the rotor housing 2-1 is provided with a flow guide disk structure 1-3 for uniformly directing the water flow to the position of the rotor blades 2-3 on the inner sidewall of the rotor housing 2-1. The flow guide disk structure 1-3 comprises a conical flow guide head 1-4 and water split blades 1-5 uniformly distributed on an outer edge of the flow guide head 1-4. A pointed end of the flow guide head 1-4 faces toward the incoming water.

This design performs adaptive optimization on the tubular structure of the valve device to ensure the rotational push of the water flow for the rotor component. The flow guide disk structure is disposed in the central region of the water inflow end of the rotor housing. The middle conical or cone-like flow guide head can uniformly disperse the incoming water outwardly so as to ensure the water flow preferentially runs through the position of the rotor blades on the inner sidewall of the rotor housing. In this case, the problem that when the incoming water runs at a small flow rate, the water flow can only run through a local area inside the rotor housing and thus cannot push the rotor blades to drive the rotation of the rotor can be avoided. This structure can effectively guarantee the normal operation of the power generation function of the valve.

In the technical solution provided by this embodiment, an electric control box 1-1 is disposed at an outer side surface of the valve outer housing 1, and the power transformation and storage module and the primary control module are both integrated into the electric control box 1-1. Furthermore, the primary control module is further connected with a remote communication module.

This design optimizes the circuit control structure design of the power generator. An electric control part is integrated into the electric control box outside the valve outer housing and thus fully separated from the internal water connection part structure, thereby increasing insulation performance and ensuring normal operation of the electric part. Further, the remote communication module is disposed to facilitate obtaining real-time information of the valve operation by the remote end or completing remote operation control. In addition, the valve may also, in special circumstances, perform control actions other than those normal feedback adjustments, for example, perform temporary opening or closing or the like.

Although the present disclosure is described as above, the scope of protection of the present disclosure is not limited hereto. Those skilled in the arts can make various variations and modifications to the present disclosure without departing from the spirit and scope of the present disclosure and these variations and modifications all fall within the scope of protection of the present disclosure.

1. A micro-generation self-energized water transportation pipe adjustment valve device, wherein the device comprises a tubular valve outer housing (1) with both ends connected to a pipe, a valve component (3) fixedly mounted at one end inside the valve outer housing (1), and a rotor component (2) located at the other end inside the valve outer housing (1); a coil winding is disposed on an inner side surface of an end of the valve outer housing (1) cooperating with the rotor component (2); the rotor component (2) comprises a rotor housing (2-1), permanent magnet groups (2-2) uniformly distributed outside the rotor housing (2-1) and rotor blades (2-3) spirally distributed on an inner sidewall of the rotor housing (2-1); the rotor housing (2-1) is coaxially and rotatably nested into the valve outer housing (1); the valve component (3) comprises a switching actuator and an electrically-controlled switching mechanism; a wire connection end of the coil winding is connected with a power transformation and storage module configured to store, in a transformation way, relative rotational induction generation between the rotor component (2) and the coil winding under the drive of water flow; the electrically-controlled switching mechanism is also connected with the power transformation and storage module such that the electrically-controlled switching mechanism is powered by the power transformation and storage module to control a closing or opening degree of the switching actuator.

2. The micro-generation self-energized water transportation pipe adjustment valve device of claim 1, wherein the self-adjusting valve device further comprises a feedback adjustment component which comprises a hydraulic pressure sensor disposed at a position in contact with the water flow inside the valve outer housing (1) and a primary control module connected with the hydraulic pressure sensor; the primary control module is connected with the power transformation and storage module and the electrically-controlled switching mechanism in a controlled manner to adaptively adjust a movement output by the electrically-controlled switching mechanism based on collected hydraulic pressure information so as to change the opening or closing action of the switching actuator.

3. The micro-generation self-energized water transportation pipe adjustment valve device of claim 2, wherein the feedback component further comprises a rotation speed measurer connected to the rotor housing (2-1) in an induction manner to measure a rotation speed of the rotor housing (2-1) and also connected to the primary control module to output rotation information to a rotation speed module.

4. The micro-generation self-energized water transportation pipe adjustment valve device of claim 1, wherein the valve component (3) further comprises a valve inner chamber (3-2) disposed inside the valve outer housing (1); the valve inner chamber (3-2) has a sphere-like chamber structure; the switching actuator is a valve ball (3-7) which matches the shape of the valve inner chamber (3-2) and can adjust the openness of the valve inner chamber (3-2) by axial feed.

5. The micro-generation self-energized water transportation pipe adjustment valve device of claim 4, wherein the electrically-controlled switching mechanism comprises a valve inner bracket for supporting and connecting the valve ball (3-7) and a valve drive motor (3-1) for driving the valve ball (3-7) to perform axial feed movement.

6. The micro-generation self-energized water transportation pipe adjustment valve device of claim 5, wherein a screw rod (3-6) is coaxially fixed at a base of the valve ball (3-7); the valve inner bracket comprises an outer gear nut (3-4) in thread cooperation with the screw rod (3-6); an output shaft of the valve drive motor (3-1) is engaged with an outer edge of the outer gear nut (3-4) through a connection gear to output rotation and hence drive the rotation of the outer gear nut (3-4) so as to drive the screw rod (3-6) to perform axial feed movement.

7. The micro-generation self-energized water transportation pipe adjustment valve device of claim 6, wherein the valve inner bracket further comprises a bracket housing (3-8) in which the outer gear nut (3-4) and the valve drive motor (3-1) both are received; an end of the bracket housing (3-8) at the screw rod (3-6) is further provided with a screw rod (3-6) sleeve (3-5) for supporting the screw rod (3-6); the bracket housing (3-8) and the valve inner chamber (3-2) are fixedly connected via spoke structures (3-9).

8. The micro-generation self-energized water transportation pipe adjustment valve device of claim 7, wherein an end of the bracket housing (3-8) facing toward the rotor component (2) is provided with a convex cone-shaped chamber structure (3-3) for providing a feed allowance for the screw rod (3-6) and directing the water flow to have less impact on the bracket housing (3-8).

9. The micro-generation self-energized water transportation pipe adjustment valve device of claim 7, wherein an extension structure extending to the valve outer housing (1) is disposed on an outer end of the valve inner chamber (3-2), and turned out at an opening position of the valve outer housing (1) to form a pipe mouth docking structure (1-2); an end of the valve outer housing (1) at the rotor component (2) is also provided with a pipe mouth docking structure (1-2); both of the pipe mouth docking structures (1-2) are used to fixedly dock with upstream and downstream pipes.

10. The micro-generation self-energized water transportation pipe adjustment valve device of claim 1, wherein an inlet end of the rotor housing (2-1) is provided with a flow guide disk structure (1-3) for uniformly directing the water flow to the position of the rotor blades (2-3) on the inner sidewall of the rotor housing (2-1); the flow guide disk structure (1-3) comprises a conical flow guide head (1-4) and water split blades (1-5) uniformly distributed on an outer edge of the flow guide head (1-4); a pointed end of the flow guide head (1-4) faces toward the incoming water.

11. The micro-generation self-energized water transportation pipe adjustment valve device of claim 3, wherein an electric control box (1-1) is disposed at an outer side surface of the valve outer housing (1), and the power transformation and storage module and the primary control module are both integrated into the electric control box (1-1); the primary control module is further connected with a remote communication module.
